(19) United States
(12) Patent Application Publication
(10) Pub. No.: US 2010/0162133 A1
(43) Pub. Date: Jun. 24, 2010

(54) USER INTERFACE PARADIGM FOR NEXT-GENERATION MOBILE MESSAGING

(75) Inventors: Kristin Marie Pascal, Bothell, WA (US); Andrew Evan Klonsky, Portland, OR (US); Matthew James Bailey, Seattle, WA (US)

Correspondence Address: AT&T Legal Department - T&W;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 12/343,359

(22) Filed: Dec. 23, 2008

(51) Int. Cl. G06F 3/048

(52) U.S. Cl. 715/752

(57) ABSTRACT

Systems and methods for enabling people to more efficiently capture, process, and communicate ideas are presented herein. A display component can present multimedia content communicated via a wireless communications device as a sequential list of dialog balloons justified towards a left or right side of a display. Each dialog balloon can correspond to a message of a conversation between a user of the wireless communications device and at least one other person. A multimedia component can enable the user to include text and at least one of a picture, a video, a map, an emoticon, or audio within a dialog balloon corresponding to a message communicated by the user. A message communicated by the user can be justified towards the right side of the display, and a message communicated by the at least one other person can be justified towards the left side of the display.

### TECHNICAL FIELD

This disclosure relates generally to communications systems, and in particular, but not exclusively, relates to a user interface paradigm for next-generation mobile messaging devices.

### BACKGROUND

Wireless communications devices (e.g., mobile phones, cell phones, personal data assistants, etc.) are ubiquitous because they enable people to stay in contact with each other. Such devices can be used by people to stay connected with friends and family and/or for business purposes (e.g., to coordinate meetings, to conduct other business affairs, etc).

Various applications exist to help persons communicate with other people via wireless communications devices. Such applications include instant messaging (IM) and electronic mail (e.g., email). Instant messaging applications are commonly used to transfer short text messages between mobile phone devices, and facilitate communication by consecutively displaying the text messages in a list as they are communicated. IM applications are based on an industry standard Short Message Service (SMS) communications protocol, which enables a wireless communications device to transfer and display text messages.

Besides rudimentarily displaying the text of messages, IM applications can display text messages within a speech balloon (e.g., speech bubble, dialogue balloon, word balloon, conversation bubble, etc.). Speech balloons (and the like) facilitate more efficient communication by enabling persons to better perceive words as speech, thoughts, and/or ideas communicated in a conversation. In this way, IM applications that utilize speech balloons can improve communication via a wireless communications device.

Multimedia Messaging Service (MMS) is a cellular phone standard that was developed to enhance SMS protocol, and thus IM applications, by enabling mobile phone users to send and receive multimedia content (e.g., photos) via their mobile phones. However, conventional MMS technology does not enable IM applications, or any other application, to display text and multimedia content within a speech balloon in a conversational manner via a wireless communications device.

Email applications enable the transfer of messages (or emails) over various communications networks, including wireless networks. Emails are usually composed using a text editor and sent to a recipient's address via a communications network. To access the content of an email, whether text or multimedia content, a recipient of the email must first select an email message from a list of email messages received in the recipient's “inbox,” and then “open” the email message to access its content. Thus, unlike IM applications that simulate a conversation by displaying text messages in a list as they are communicated, email applications do not enable persons to efficiently capture and communicate information in a conversational manner.

Consequently, there is a need to provide systems and methods that combine the in-line, conversational, text-based display features of IM applications, with the ability to stream, in real-time, a combination of text, video, images, and other multimedia within a speech balloon displayed on a wireless communications device, so as to enable people to more efficiently capture, process, and communicate ideas via a wireless communications device.

### SUMMARY

The following presents a simplified summary of the innovation to provide a basic understanding of some aspects described herein. This summary is not an extensive overview of the disclosed subject matter. It is not intended to identify key or critical elements of the disclosed subject matter or delineate the scope of the subject innovation. Its sole purpose is to present some concepts of the disclosed subject matter in a simplified form as a prelude to the more detailed description that is presented later.

The claimed subject matter relates to systems and methods that enhance the ability of people to communicate. Although speech balloons utilized in IM applications facilitate efficient communication by enabling persons to better perceive text as speech, thoughts, and/or ideas communicated in a conversation, conventional technology has failed to deliver a system/method that combines the in-line, conversational, text-based display features of IM applications, with the ability to stream, in real-time, the combination of text and a picture, a video, a map, an emoticon, and/or audio video within a speech balloon displayed on a wireless communications device.

To correct for these and related shortcomings of conventional technology, the novel systems and methods of the claimed subject matter enable people to more efficiently capture, process, and communicate ideas via a wireless communications device. According to one aspect of the disclosed subject matter, a display component can present multimedia content communicated via a wireless communications device as a sequential list of dialog balloons justified towards a left or right side of a display. Each dialog balloon corresponds to a message of a conversation between a user of the wireless communications device and at least one other person. Further, a multimedia component can enable the user to include text and at least one of a picture, a video, a map, an emoticon, or audio within a dialog balloon corresponding to a message communicated by the user. By presenting multimedia content on a wireless communications device as a sequential list of dialog balloons, the claimed subject matter enhances the ability of people to communicate because people are enabled to sense multimedia information the moment it is communicated.

According to another aspect of the disclosed subject matter, a message communicated by the user can be justified towards the right side of the display, and a message communicated by the at least one other person can be justified towards the left side of the display. In this way, the claimed subject matter more effectively simulates that a conversation is occurring between the user and one or more other persons by enabling persons to separate ideas communicated between the user and the one or more other persons.

In another aspect of the subject invention, the multimedia component can improve the user's ability to sense multimedia information communicated in the display of the wireless communications device by resizing the multimedia content to fit within the display when the dialog balloon is presented on the display.

According to yet another aspect of the subject invention, a dialog component can enable the user to create a group conversation between the user and at least one other person, wherein the user and the at least one other person can receive messages communicated by the user and the at least one other person. In this way, the dialog component more effectively simulates a conversation between people by broadcasting any message communicated by participants of the conversation to all other participants (e.g., as if the people were communicating to each other in person).

In one aspect of the disclosed subject matter, the dialog component can enable the user to establish more than one group conversation. Further, the display component can present the group conversations as a list of rows, wherein each row corresponds to one of the group conversations. As a result, the subject invention improves a person's ability to communicate with others by allowing the user to manage and engage in multiple group conversations at the same time.

In another aspect of the disclosed subject matter, a message component can enable the user to compose a message based on a quick reply mode triggered by an input received from the user. The quick reply mode initiates composition of the message upon receiving the user's input. In this way, the quick reply mode enables the user to almost instantaneously send a message and/or reply to other participants of a conversation—as if participants were communicating in person. According to yet another aspect of the subject invention, the quick reply mode can be triggered when the user begins typing on/near a surface of the wireless communications device. The user's input—including at least one of characters or symbols—is immediately included in the contents of the message. In one aspect of the disclosed subject matter, the quick reply mode can be triggered when the user at least one of: slides a keyboard component coupled to the wireless communications device; presses a mechanical key coupled to the wireless communications device; initiates an activation of a capacitance sensor coupled to the wireless communications device; or initiates an activation of a microphone component coupled to the wireless communications device.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a demonstrative system for enabling people to more effectively communicate via a wireless communications device, according to an embodiment of the invention.

FIG. 2 illustrates features of a demonstrative system for enabling people to more effectively communicate via a wireless communications device, according to an embodiment of the invention.

FIG. 3 illustrates additional features of a demonstrative system for enabling people to more effectively communicate via a wireless communications device, according to an embodiment of the invention.

FIG. 4 illustrates yet more features of a demonstrative system for enabling people to more effectively communicate via a wireless communications device, according to an embodiment of the invention.

FIG. 5 illustrates another demonstrative system for enabling people to more effectively communicate via a wireless communications device, according to an embodiment of the invention.

FIG. 6 illustrates features associated with a display of a system for enabling people to more effectively communicate via a wireless communications device, according to an embodiment of the invention.

FIG. 7 illustrates additional features associated with a display of a system for enabling people to more effectively communicate via a wireless communications device, according to an embodiment of the invention.

FIG. 8 illustrates yet more features associated with a display of a system for enabling people to more effectively communicate, according to an embodiment of the invention.

FIG. 9 illustrates yet another demonstrative system for enabling people to more effectively communicate via a wireless communications device, according to an embodiment of the invention.

FIG. 10 illustrates more features associated with a system for enhancing the ability of people to communicate, according to an embodiment of the invention.

FIG. 11 illustrates a process for enabling people to more effectively communicate via a wireless communications device, according to an embodiment of the invention.

FIG. 12 illustrates features associated with a process for enabling people to more effectively communicate via a wireless communications device, according to an embodiment of the invention.

FIG. 13 illustrates features associated with including multimedia content in a message, in accordance with an embodiment of the invention.

FIG. 14 illustrates another process for enabling people to more effectively communicate via a wireless communications device, according to an embodiment of the invention.

FIG. 15 illustrates a block diagram of a computer operable to execute the disclosed systems and methods, in accordance with an embodiment of the invention.

FIG. 16 illustrates a schematic block diagram of an exemplary computing environment, in accordance with an embodiment of the invention.

### DETAILED DESCRIPTION

Embodiments of systems and methods for enabling people to more efficiently capture, process, and communicate ideas via a wireless communications device are described herein.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “in an embodiment” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a process running on a processor, a processor, an object, an executable, a program, and/or a computer. By way of illustration, an application running on a server and the server can be a component. One or more components can reside within a process and a component can be localized on one computer and/or distributed between two or more computers.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Artificial intelligence based systems (e.g., explicitly and/or implicitly trained classifiers) can be employed in connection with performing inference and/or probabilistic determinations and/or statistical-based determinations as in accordance with one or more aspects of the disclosed subject matter as described herein. For example, in one embodiment, an artificial intelligence system can be used utilized in accordance with system 100 described infra (e.g., to enable display component 110 to present multimedia content communicated via a wireless communications device as a sequential list of dialog balloons justified towards a left or right side of the wireless communication device's display).

Further, as used herein, the term “infer” or “inference” refers generally to the process of reasoning about or inferring states of the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example. Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices (e.g., hard disk, floppy disk, magnetic strips), optical disks (e.g., CD, DVD), smart cards, and flash memory devices (e.g., card, stick, key drive).

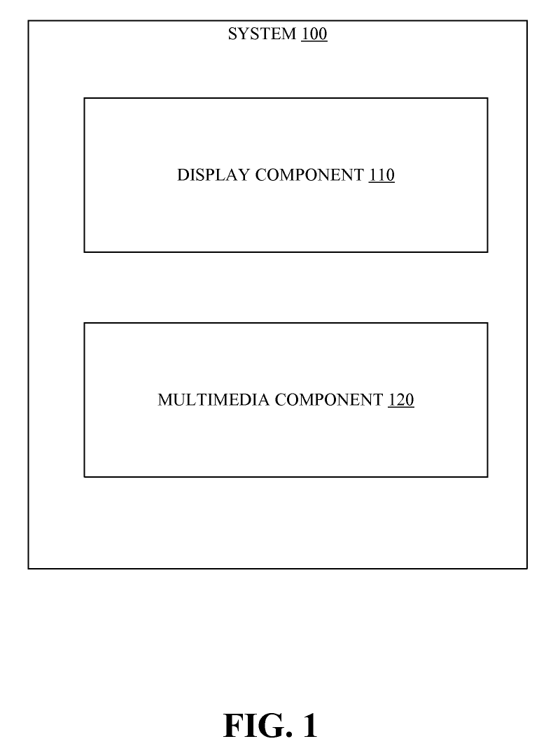

The subject invention provides systems and methods that enhance the ability of people to communicate by combining the in-line, conversational, text-based display features of IM-like applications, with the ability to stream a combination of text, video, images, and other multimedia within a speech balloon displayed on a wireless communications device. FIG. 1 illustrates a demonstrative system 100 for enabling people to more effectively communicate via a wireless communications device, according to an embodiment of the invention. System 100 and the systems and processes explained below may constitute machine-executable instructions embodied within a machine (e.g., computer) readable medium, which when executed by a machine will cause the machine to perform the operations described. Additionally, the systems and processes may be embodied within hardware, such as an application specific integrated circuit (ASIC) or the like. The order in which some or all of the process blocks appear in each process should not be deemed limiting. Rather, it should be understood by a person of ordinary skill in the art having the benefit of the instant disclosure that some of the process blocks may be executed in a variety of orders not illustrated.

As illustrated by FIG. 1, system 100 can include display component 110 and multimedia component 120. Display component 110 can present multimedia content communicated via a wireless communications device as a sequential list of dialog balloons justified towards a left or right side of the wireless communications device's display, wherein each dialog balloon corresponds to a message of a conversation between a user of the wireless communications device and at least one other person. Further, multimedia component 120 can enable the user to include text and multimedia content within a dialog balloon corresponding to a message communicated by the user, wherein the user can present a picture, a video, a map, an emoticon, and/or audio when the dialog balloon is presented. It should be appreciated that the wireless communications device can be any type of wireless communications device, such as a cellular phone, personal data assistant, or the like. However, it should be appreciated by one of ordinary skill in the art that a wireless communications device can be any kind of device capable of enabling remote communication. Further, it should be appreciated by one of ordinary skill in the art that multimedia content comprises information capable of being sensed in a variety of ways by an individual when it is communicated to the individual (e.g., through sight, sound, touch, or the like). In addition, it should be appreciated by one of ordinary skill in the art that a dialog balloon (or the like), commonly used in comic books and cartoons, allows words to be understood as representing the speech or thoughts of a person associated with the dialog balloon.

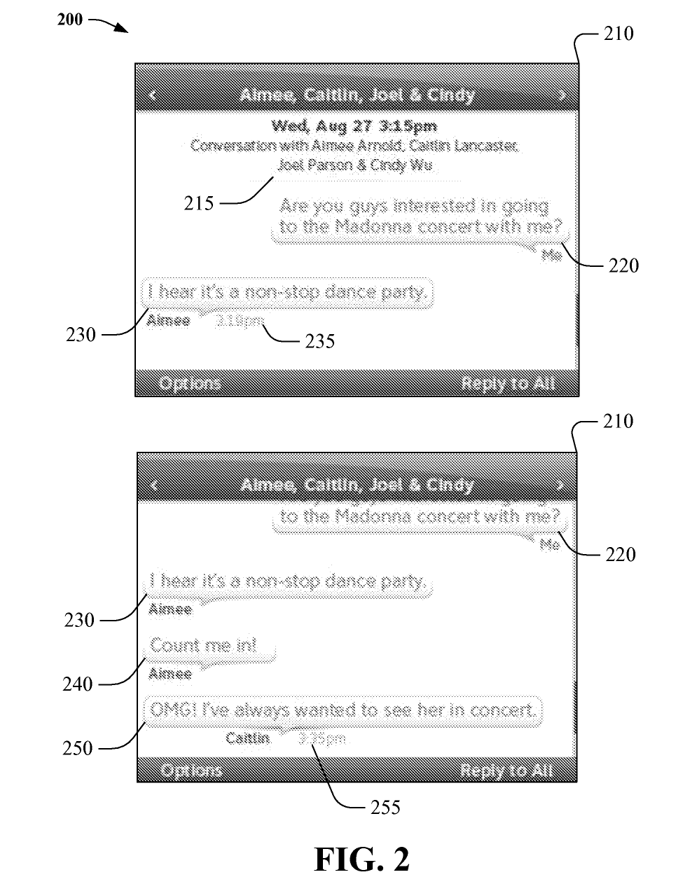

Returning to FIG. 1, by presenting multimedia content on a wireless communications device as a sequential list of dialog balloons, the claimed subject matter enhances the ability of people to communicate because persons are enabled to sense multimedia information the moment it is communicated within an associated dialog balloon. In one embodiment, a message communicated by the user can be justified towards the right side of the display, and a message communicated by the at least one other person can be justified towards the left side of the display. FIG. 2 illustrates the above discussed features of system 100, according to an embodiment of the invention. Conversation display 210 is displayed on the wireless communications device of system 100, and is associated with a conversation between a user of the wireless communications device and other participants Aimee, Caitlin, Joel, and Cindy.

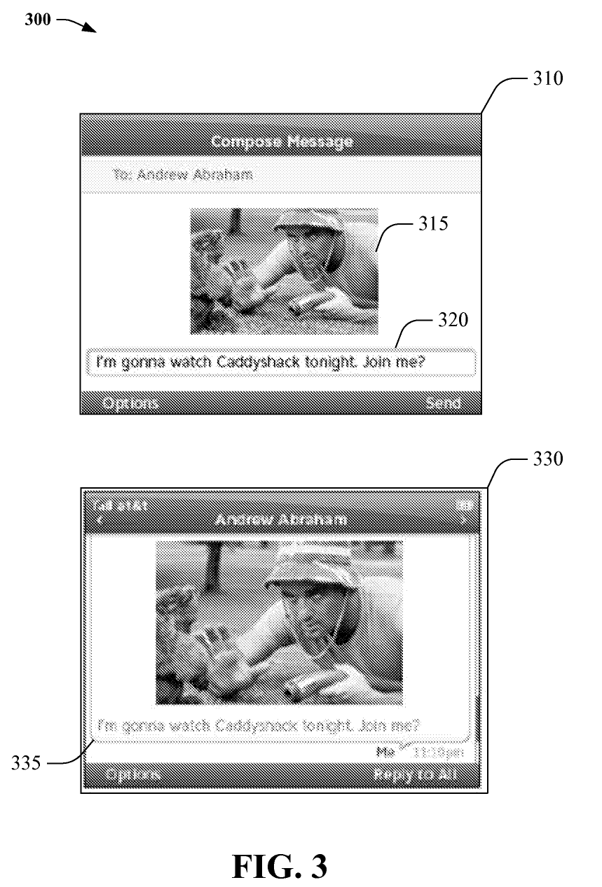

As shown, dialog balloon 220 (associated with the user) is justified towards the right of conversation display 210. On the other hand, dialog balloons 230-250, associated with other participants of the conversation (Aimee and Caitlin), are justified towards the left of conversation display 210. In this way, the claimed subject matter more effectively simulates a conversation occurring between the user and the other participants by visually separating ideas communicated between the user and the other participants. FIG. 3 illustrates multimedia component 120 enabling a user to include text and a picture within a dialog balloon corresponding to a message communicated by the user, in accordance with an embodiment of the invention. Compose message display 310 depicts the user including picture 315 and text 320 in a message to Andrew Abraham, who is participating in a conversation with the user. As depicted by conversation display 330, display component 110 presents the text and picture the user included in the message, in one instance, within dialog balloon 335. Further, in the embodiment depicted by conversation display 330, multimedia component 120 can improve the ability of the participants in a conversation to sense multimedia information communicated in the display of the wireless communications device by resizing the multimedia content to fit within the display when the dialog balloon is presented on the display. Thus, unlike conventional technology, the claimed subject matter enhances the ability of people to communicate because persons are enabled to sense multimedia information the moment it is communicated via a dialog balloon.

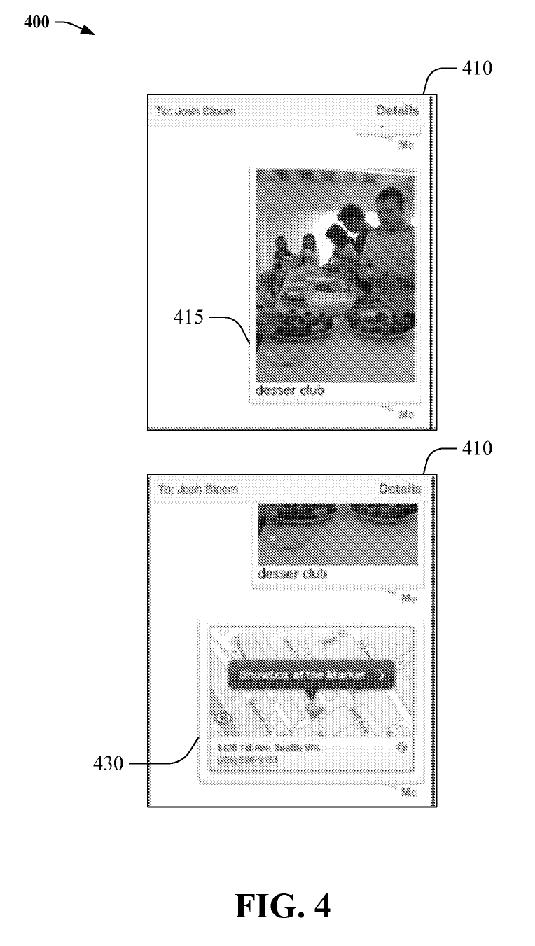

Although not shown, a user can include a video, a map, emoticons (see infra), and/or audio within the content of a message, so that participants in a conversation can sense the video, map, emoticons, and/or audio the moment such information is communicated via a dialog balloon. For example, if the user includes audio (e.g., music, recorded speech, etc.) in the dialog balloon, the wireless communications device plays the audio when the dialog balloon is displayed on the wireless communications device. In another example, if the user includes video (e.g., movie, video broadcast of news story, etc.) in the dialog balloon, the wireless communications device plays the video within the dialog balloon when the dialog balloon is displayed. Now referring to FIG. 4, conversation display 410 depicts consecutive messages (associated with dialog balloons 415 and 430) presented by display component 110, in accordance with an embodiment of the invention. As shown, dialog balloon 415 displays text and an associated picture, while dialog balloon 430 displays text and a map.

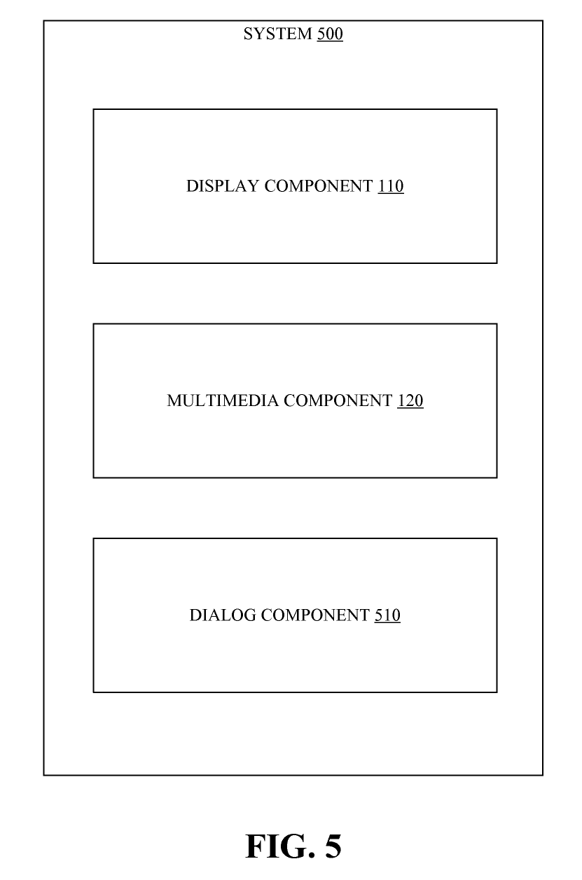

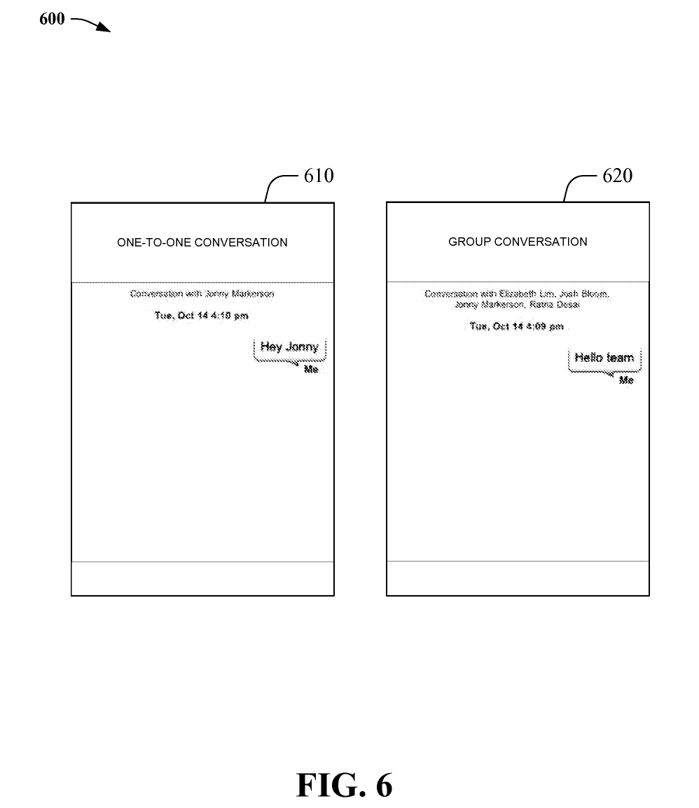

FIG. 5 illustrates a demonstrative system 500 for enabling people to more effectively communicate via a wireless communications device, according to an embodiment of the invention. System 500 can include, in addition to the components of system 100, dialog component 510. Dialog component 510 can create a conversation between the user and the at least one other person when the user sends a message from the wireless communications device to the at least one other person. Dialog component 510 can create the conversation based on, at least in part, whether the at least one other person previously received a message from the user. For example, in one embodiment, if the user addresses a message to the same recipient(s) the user previously addressed the message to, dialog component 510 would not create a new conversation between the participant(s), but would send the message within an existing conversation between the user and the participants. Now referring to FIG. 6, conversations created by dialog component 510 are illustrated in accordance with an embodiment of the invention. Conversation display 610 depicts a conversation (e.g., one-to-one conversation) created by dialog component 510 as a result of the user sending a message (e.g., “Hey Jonny”) to Jonny Markerson. In reference to the discussion supra, if the user addresses another message to Jonny Markerson, the dialog component 510 would not create a new conversation, but would include the message in the conversation depicted by conversation display 610.

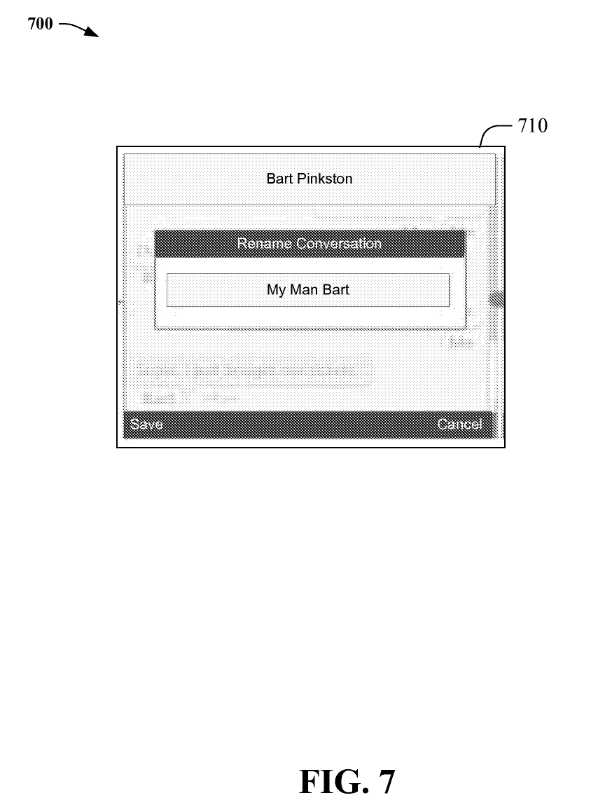

In one embodiment, dialog component 510 enables the user to create a group conversation between the user and the at least one other person. In a group conversation, all participants in the group conversation receive messages communicated within the group conversation. It should be appreciated that participants in a group conversation can alternatively send messages “outside” of a group conversation, so that those messages are not broadcast among participants of a group conversation. Conversation component 620 depicts a group conversation created by dialog component 510 as a result of the user sending a message (e.g., “Hello Team”) to “Elizabeth, John and 2 more (persons)”. In another embodiment, display component 120, in a default mode, can present a person's first and last names as the title of a conversation when the conversation is a one-to-one conversation (see supra) between the user and the person. If dialog component 510 creates a group conversation between more than two persons, display component 120, in a default mode, creates a default name for the conversation (e.g., “Conversation”) and presents the default name as the title of the conversation. However, display component 120 further enables the user to rename one-to-one conversations and group conversations, as depicted by conversation name display 710 in FIG. 7.

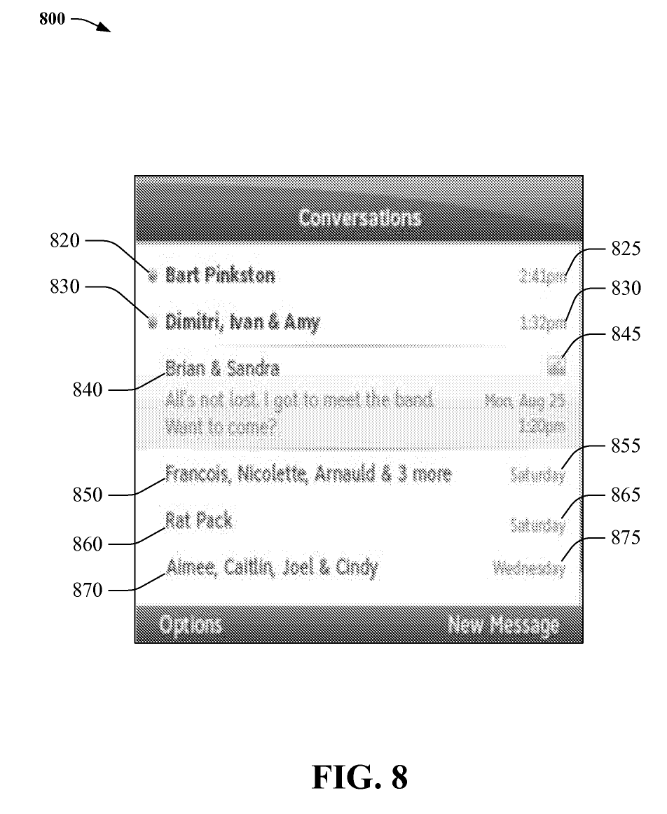

In another embodiment of the invention, dialog component 510 can enable the user to establish a plurality of conversations, and display component 120 can present the plurality of conversations as a list of rows—each row corresponding to one of the conversations. Now referring to FIG. 8, a display in accordance with an embodiment of the invention is illustrated. As depicted, display component 810 shows 6 conversations (820-870) maintained by dialog component 501. In this way, the subject invention can enable more efficient communication with others by allowing the user to manage and engage in multiple conversations with multiple persons at the same time. In one embodiment, the name of the conversation can include, in a default mode, a first and last name of a person the user is communicating with when the conversation is a one-to-one conversation between the user and the person (see, e.g., 820). Also, in the default mode, the name of the conversation can include first names of persons participating in a group conversation (see, e.g., 830, 840, 850, and 870). Further, the user can rename conversation names as described supra (see, e.g., 860).

In yet another embodiment, display component 120 can present the plurality of conversations in chronological order. A conversation associated with a most recent message transferred/received by the wireless communications device can be displayed at the top of the list of rows, while remaining conversations can be successively displayed in rows below the top of the list of rows in order from conversations associated with the next recent message transferred/received to conversations associated with the least recent message transferred/received. Referring to FIG. 8, display component 120 displays conversation 820 at the top of the list of conversations because it is associated with the most recent message transmitted/received via the wireless communications device. In contrast, conversation 870 is displayed at the bottom of the list of conversations because it is associated with the least recent message.

In another embodiment of the invention, each row of conversations can include a plurality of lines. Display component 120 can present a name of a conversation associated with a row on the first line of the row, and a preview of the most recent message of the conversation transferred/received on the second line of the row (see, e.g., 840 of FIG. 8). In yet another embodiment, display component 120 can present a timestamp of the most recent message of the conversation on the first line of the row (see, e.g., 825 and 830 of FIG. 8). Display component can also present timestamps between dialog balloons when a period of time has elapsed between messages communicated between the user and at least one other person of the conversation (not shown).

In one embodiment, the timestamp can include: a time the most recent message was transferred/received, when the most recent message was transferred/received during the current calendar day (see, e.g., 825 and 830 of FIG. 8); a name of the day the most recent message was transferred/received, when the most recent message was transferred/received more than one day from the current calendar day, but less than one month from the current calendar day (see, e.g., 855, 865, and 875 of FIG. 8); a day and month the most recent message was transferred/received, when the most recent message was transferred/received more than one month from the current calendar day, but less than one year from the current calendar day (not shown); or a day, month, and year the most recent message was transferred/received, when the most recent message was transferred/received more than one year from the current calendar day (not shown). In another embodiment, display component 120 can present one or more visual indicators in a row associated with a conversation. The one or more visual indicators can indicate at least one of: a message of the conversation is unread (see, e.g., 820 and 830); a message of the conversation contains media, wherein the media can include at least one of a video, an image, a photo, or music (see, e.g., 845); or a focus state is set in which greater information is revealed about the conversation (see, e.g., 845).

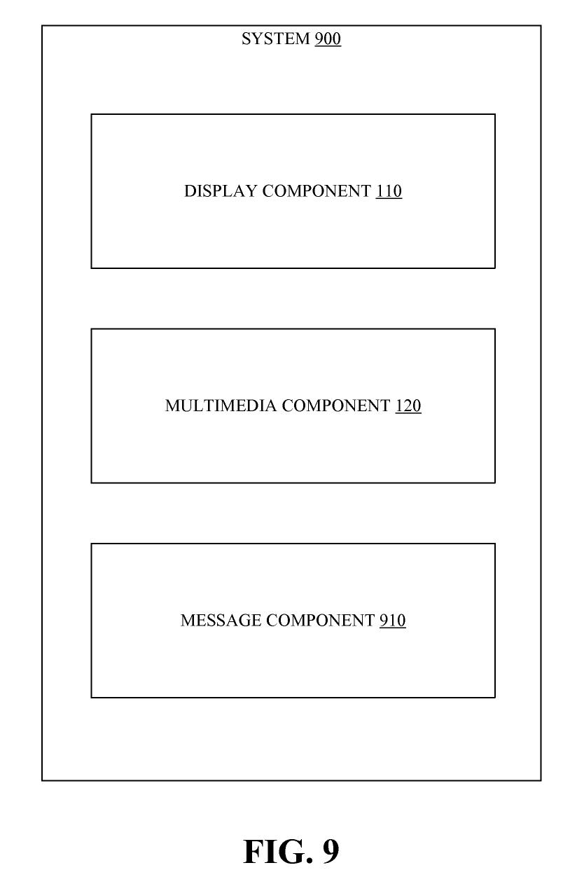

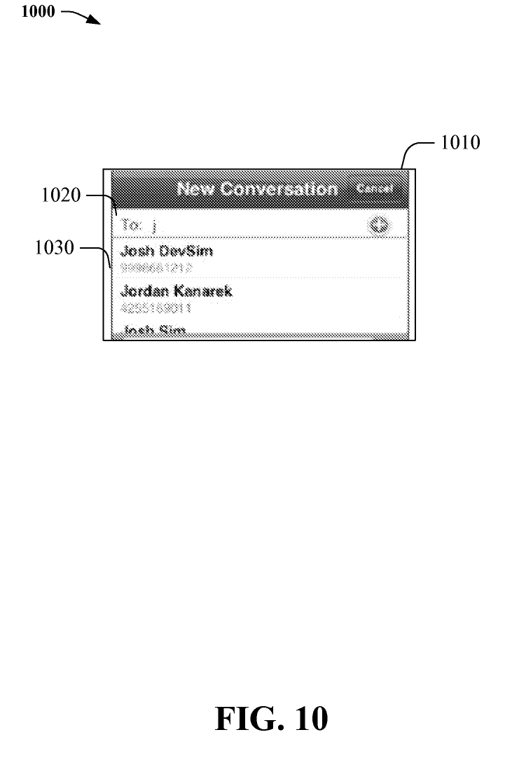

FIG. 9 illustrates a demonstrative system 900 for enabling people to more effectively communicate via a wireless communications device, according to an embodiment of the invention. System 900 can include, in addition to the components of system 100, message component 910. Message component 910 can enable the user to compose a message by generating a list of message recipients upon the user selecting characters to be entered in a field of a message composition display. The list can include message recipients whose first or last name starts with the first character selected by the user, wherein subsequent characters selected by the user continue to filter the list based on the subsequently selected characters. Referring now to FIG. 10, message composition display 1010, according to an embodiment of the invention, depicts that a user had selected “j” to input as the first character of recipient list 1020. As shown, filtered list 1030 displays names of contacts (e.g., potential message recipients) whose first names begin with the letter “j”. In another embodiment (not shown), message composition component 910 can enable the user to enter phone numbers and/or email addresses in the field of message composition display 1010.

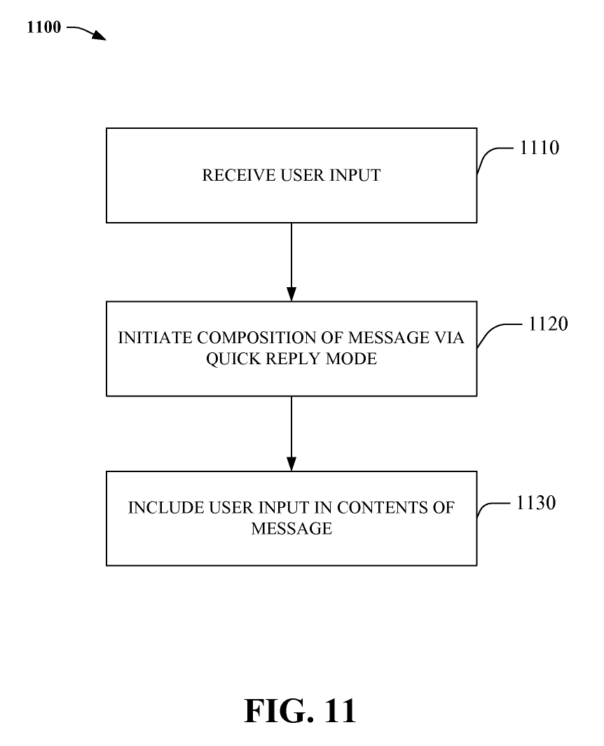

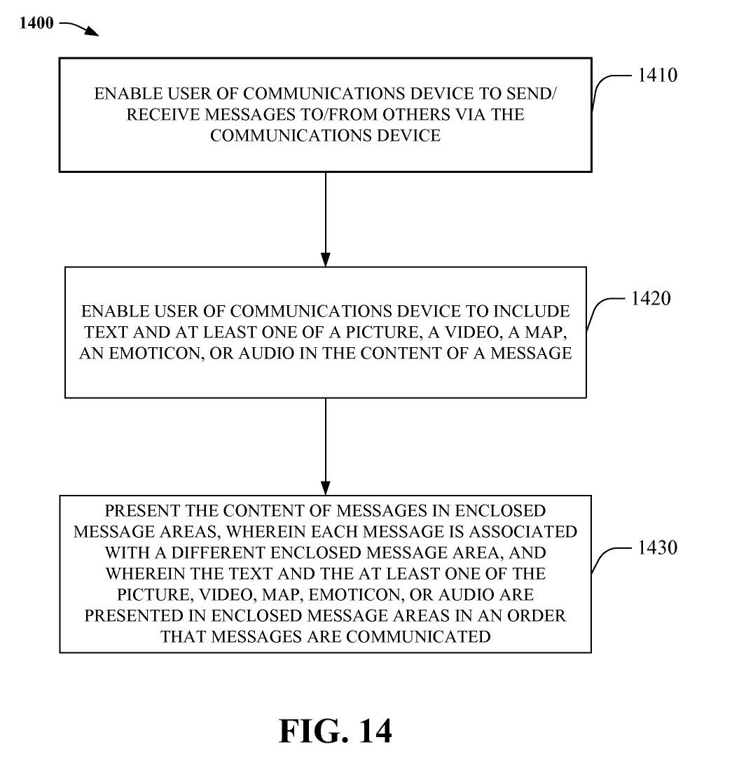

FIGS. 11 and 14 illustrate methodologies in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 11, and system 900 described supra, a process 1100 for enabling people to more effectively communicate via a wireless communications device is illustrated, in accordance with an embodiment of the invention. At 1110, message component 910 can receive user input. In response to the user input, message component 910 can initiate composition of a message at 1120 in a “quick reply” mode, based on receiving the user input. In one embodiment, the quick reply mode can be triggered when the user begins typing on a surface of the wireless communications device, wherein the user's input comprises at least one of characters or symbols entered by the user. Importantly, the user's input is immediately included in the content of the message. In another embodiment, the quick reply mode can be triggered when the user at least one of: slides a keyboard component coupled to the wireless communications device; presses a mechanical key coupled to the wireless communications device; initiates an activation of a capacitance sensor coupled to the wireless communications device; or initiates an activation of a microphone component coupled to the wireless communications device. It should be appreciated by one of ordinary skill in the art that the quick reply mode can be triggered upon receiving any user input.

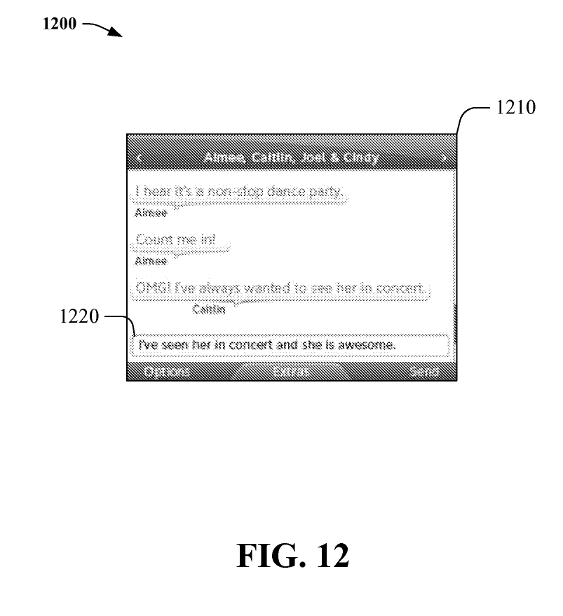

As shown in FIG. 12, conversation display 1210 depicts a group conversation in quick reply mode. Upon receiving user input (e.g., activation of a capacitance sensor coupled to the wireless communications device), message component 910 can immediately (or soon thereafter) display a message composition input reception area 1220 in which message component 910 can include the user input (e.g., characters, symbols, or the like) that activated the quick reply mode (and user input received thereafter).

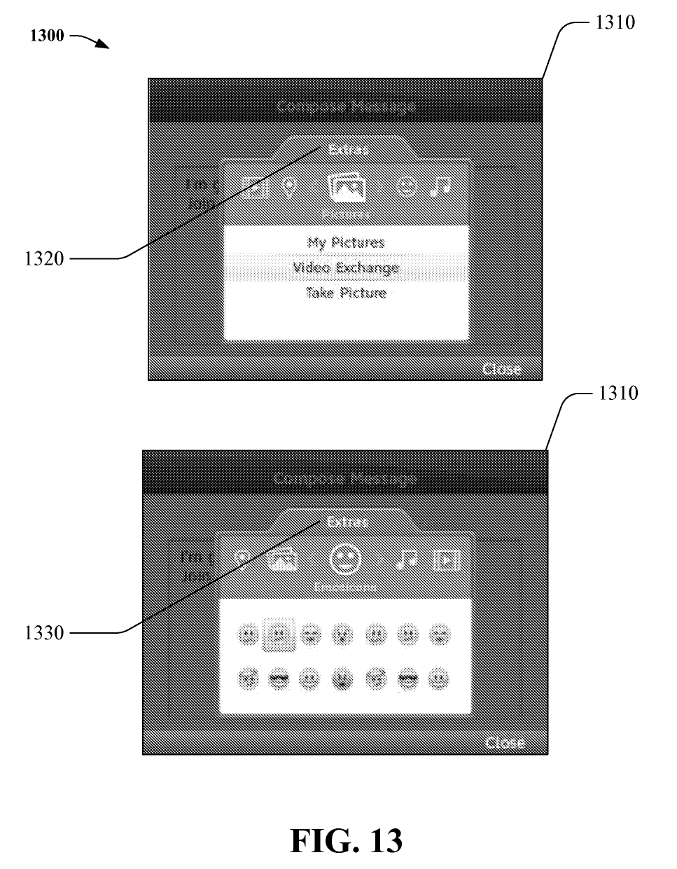

In another embodiment illustrated by FIG. 13, message component 910 can display a multimedia selection menu 1320 associated with a message composition display 1310. Multimedia selection menu 1320 can display a plurality of images (e.g., icons below the “Extras” tab displayed in multimedia selection menu 1320) in a carousel (or round-about) form. Accordingly, in response to user input, message component 910 can shift the display of the plurality of images to the left or right to enable the user to select at least one of the picture, the video, the map, the emoticon, or the audio to present from the dialog balloon. As illustrated by multimedia selection menu 1330, when an icon corresponding to “Emoticons” is shifted to the “center” of the carousel, various emoticons are displayed to enable user selection of an appropriate emoticon. It should be appreciated by one of ordinary skill in the art that any image can be displayed by multimedia selection menu 1320, and any multimedia component can be associated with the image. In yet another embodiment, the at least one of the picture, the video, the map, the emoticon, or the audio is at least stored on the device or stored on a remote device. If such information is stored on the remote device, message component 910 can enable the content stored on the remote device to be mirrored on the wireless communications device.

FIG. 14 illustrates a process 1400 for enabling people to more effectively communicate via a wireless communications device, according to an embodiment of the invention. At 1410 a user of a communications device can be enabled to send/receive messages to/from one or more persons via the communications device. The user of the communications device can further be enabled to include text and at least one of a photo, a picture, a video, a map, an emoticon, or audio in the content of a message at 1420. At 1430, content of messages sent/received via the communications device can be enclosed in message areas—each message can be associated with a different enclosed message area. Further, the enclosed message areas can present the text and at the at least one of the picture, video, map, emoticon, or audio in an enclosed message area in an order that messages are communicated via the communications device.

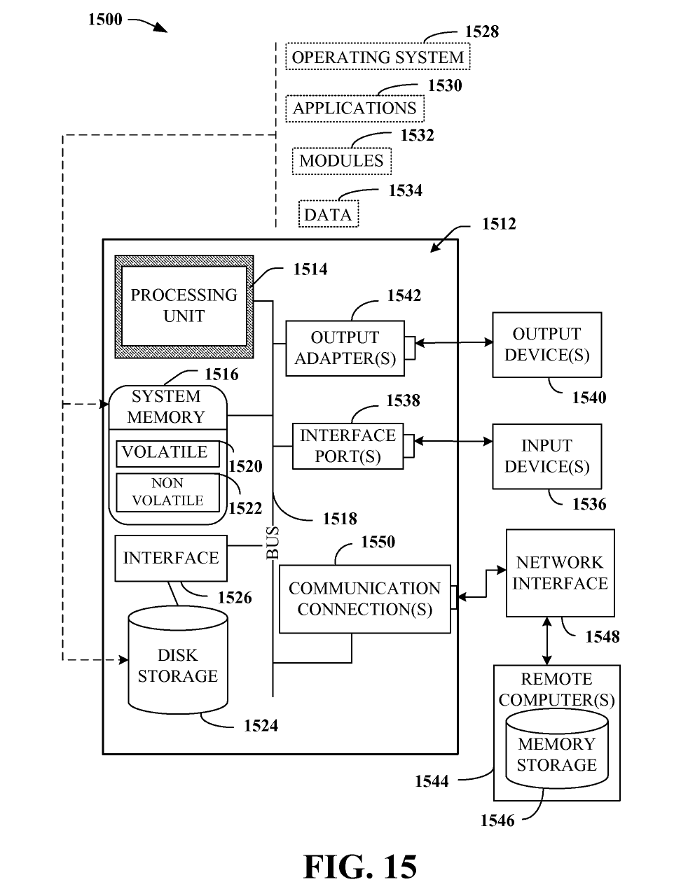

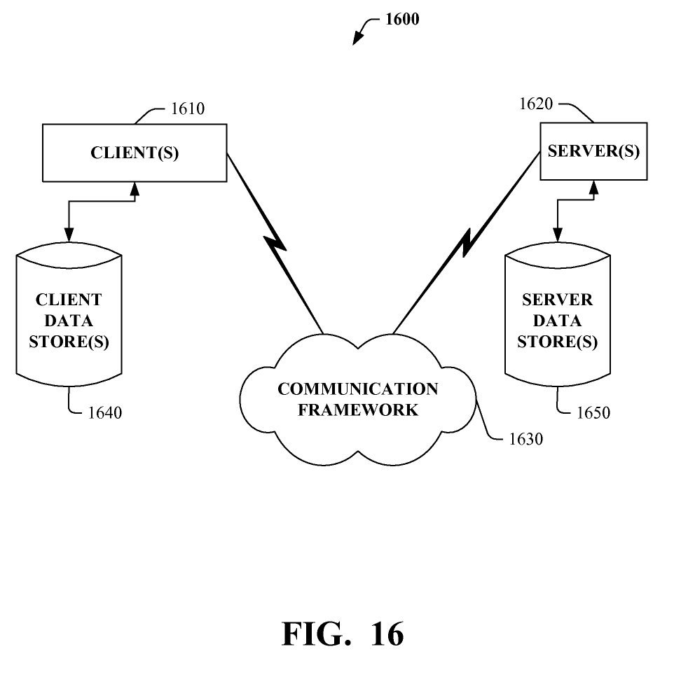

In order to provide a context for the various aspects of the disclosed subject matter, FIGS. 15 and 16, as well as the following discussion, are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types.

Moreover, those skilled in the art will appreciate that the inventive systems may be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 15, a block diagram of a computer 1500 operable to execute the disclosed systems and methods, in accordance with an embodiment of the invention, includes a computer 1512. The computer 1512 includes a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include ROM, PROM, EPROM, EEPROM, or flash memory. Volatile memory 1520 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1512 also includes removable/non-removable, volatile/non-volatile computer storage media. FIG. 15 illustrates, for example, disk storage 1524. Disk storage 1524 includes, but is not limited to, devices like a magnetic disk drive, floppy disk drive, tape drive, Jaz drive, Zip drive, LS-100 drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used, such as interface 1526.

It is to be appreciated that FIG. 15 describes software that acts as an intermediary between users and the basic computer resources described in the suitable operating environment 1500. Such software includes an operating system 1528. Operating system 1528, which can be stored on disk storage 1524, acts to control and allocate resources of the computer system 1512. System applications 1530 take advantage of the management of resources by operating system 1528 through program modules 1532 and program data 1534 stored either in system memory 1516 or on disk storage 1524. It is to be appreciated that the disclosed subject matter can be implemented with various operating systems or combinations of operating systems.

A user enters commands or information into the computer 1511 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536.

Thus, for example, a USB port may be used to provide input to computer 1512, and to output information from computer 1512 to an output device 1540. Output adapter 1542 is provided to illustrate that there are some output devices 1540 like monitors, speakers, and printers, among other output devices 1540, which require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512.

For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1550 refer(s) to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems and DSL modems, ISDN adapters, and Ethernet cards.

FIG. 16 illustrates a schematic block diagram of an exemplary computing environment 1630, in accordance with an embodiment of the invention. The system 1600 includes one or more client(s) 1610. The client(s) 1610 can be hardware and/or software (e.g., threads, processes, computing devices). The system 1600 also includes one or more server(s) 1620. Thus, system 1600 can correspond to a two-tier client server model or a multi-tier model (e.g., client, middle tier server, data server), amongst other models. The server(s) 1620 can also be hardware and/or software (e.g., threads, processes, computing devices). The servers 1620 can house threads to perform transformations by employing the subject innovation, for example. One possible communication between a client 1610 and a server 1620 may be in the form of a data packet transmitted between two or more computer processes.

The system 1600 includes a communication framework 1630 that can be employed to facilitate communications between the client(s) 1610 and the server(s) 1620. The client(s) 1610 are operatively connected to one or more client data store(s) 1640 that can be employed to store information local to the client(s) 1610. Similarly, the server(s) 1620 are operatively connected to one or more server data store(s) 1650 that can be employed to store information local to the servers 1620.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art should recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer implemented system for presenting multimedia content on a display of a wireless communications device, comprising a memory having stored therein computer executable components and a processor that executes the following computer executable components:
a display component that presents multimedia content communicated via the wireless communications device as a sequential list of dialog balloons justified towards a left or right side of the display, wherein each dialog balloon corresponds to a message of a conversation between a user of the wireless communications device and at least one other person; and
a multimedia component that enables the user to include text and at least one of a picture, a video, a map, an emoticon, or audio within a dialog balloon corresponding to a message communicated by the user.

2. The system of claim 1, wherein a message communicated by the user is justified towards the right side of the display, and wherein a message communicated by the at least one other person is justified towards the left side of the display.

3. The system of claim 1, wherein the multimedia component resizes the multimedia content to fit within the display when the dialog balloon is presented on the display.

4. The system of claim 1, further comprising:
a dialog component that creates the conversation between the user and the at least one other person when the user sends a message from the wireless communications device to the at least one other person, wherein the dialog component creates the conversation based on, at least in part, whether the at least one other person previously received a message from the user.

5. The system of claim 4, wherein the dialog component enables the user to create a group conversation between the user and the at least one other person, wherein the user and the at least one other person receive group messages communicated by the user and the at least one other person.

6. The system of claim 5, wherein the display component at least one of:
in a default mode, presents a person's first and last name as the title of the conversation when the conversation is a one-to-one conversation between the user and the person;
in the default mode, creates a name of the conversation and presents the name as the title of the conversation when the conversation is a group conversation; or
enables the user to rename one-to-one conversations and group conversations.

7. The system of claim 4, wherein the dialog component enables the user to establish a plurality of conversations, wherein the display component presents the plurality of conversations as a list of rows, and wherein each row corresponds to a conversation of the plurality of conversations.

8. The system of claim 7, wherein the display component presents the plurality of conversations in chronological order, wherein a conversation associated with a most recent message transferred/received by the wireless communications device is displayed at the top of the list of rows; and wherein remaining conversations are successively displayed in rows below the top of the list of rows in order from conversations associated with the next recent message transferred/received to conversations associated with the least recent message transferred/received.

9. The system of claim 8, wherein each row comprises a plurality of lines, wherein the display component presents a name of a conversation associated with a row on the first line of the row, and wherein the display component presents a preview of the most recent message of the conversation on the second line of the row.

10. The system of claim 9, wherein the display component presents a timestamp of the most recent message of the conversation on the first line of the row.

11. The system of claim 1, wherein the display component presents timestamps between dialog balloons when a period of time has elapsed between messages communicated between the user and the at least one other person.

12. The system of claim 9, wherein the name of the conversation comprises, in a default mode, a first and last name of a person the user is communicating with when the conversation is a one-to-one conversation between the user and the person; and wherein the name of the conversation comprises, in the default mode, first names of persons participating in a group conversation

13. The system of claim 10, wherein the timestamp comprises:
a time the most recent message was transferred/received, when the most recent message was transferred/received during the current calendar day;
a name of the day the most recent message was transferred/received, when the most recent message was transferred/received more than one day from the current calendar day, but less than one month from the current calendar day;
a day and month the most recent message was transferred/received, when the most recent message was transferred/received more than one month from the current calendar day, but less than one year from the current calendar day; or
a day, month, and year the most recent message was transferred/received, when the most recent message was transferred/received more than one year from the current calendar day.

14. The system of claim 7, wherein the display component presents one or more visual indicators in a row associated with a conversation, and wherein the one or more visual indicators indicate at least one of:
a message of the conversation is unread;
a message of the conversation contains media, wherein the media comprises at least one of a video, an image, a photo, or music; or
a focus state is set in which greater information is revealed about the conversation.

15. The system of claim 1, further comprising:
a message component that enables the user to compose a message, wherein the message component at least one of:
generates a list of message recipients upon the user selecting characters to be entered in a field of a message composition display, wherein the list comprises message recipients whose first or last name starts with the first character selected by the user, and wherein subsequent characters selected by the user continue to filter the list based on the subsequently selected characters;
enables the user to enter phone numbers in the field of the message composition display; or
enables the user to enter email addresses in the field of the message composition display.

16. The system of claim 15, wherein the message component enables the user to compose the message based on a quick reply mode triggered by an input received from user, wherein the quick reply mode initiates composition of the message upon receiving the user's input.

17. The system of claim 16, wherein the quick reply mode is triggered when the user begins typing on a surface of the wireless communications device, wherein the user's input comprises at least one of characters or symbols entered by the user, and wherein the user's input is included in the content of the message.

18. The system of claim 16, wherein the quick reply mode is triggered when the user at least one of:
slides a keyboard component coupled to the wireless communications device;
presses a mechanical key coupled to the wireless communications device;
initiates an activation of a capacitance sensor coupled to the wireless communications device; or
initiates an activation of a microphone component coupled to the wireless communications device.

19. The system of claim 15, wherein the message component displays a multimedia selection menu associated with the message composition display; wherein the multimedia selection menu displays a plurality of images as a carousel; wherein the message component shifts the display of the plurality of images to the left or right to enable the user to select at least one of the picture, the video, the map, the emoticon, or the audio to be presented within the dialog balloon; wherein the at least one of the picture, the video, the map, the emoticon, or the audio is at least stored on the device or stored on a remote device; and wherein the message component enables the content stored on the remote device to be mirrored on the wireless communications device.

20. A computer-readable storage medium having computer executable components for:
enabling a user of a communications device to send/receive messages to/from one or more persons via the communications device;
enabling the user of the communications device to include text and at least one of a picture, a video, a map, an emoticon, or audio in content of a message; and
presenting the content of messages sent/received via the communications device in enclosed message areas, wherein each message is associated with a different enclosed message area, and wherein the text and the at least one of the picture, video, map, emoticon, or audio are presented in enclosed message areas in an order that messages are communicated via the communications device.

21. A method comprising:
enabling a user of a communications device to send/receive messages to/from one or more persons via the communications device;
enabling the user of the communications device to include text and at least one of a picture, a video, a map, an emoticon, or audio in content of a message; and
presenting the content of messages sent/received via the communications device in enclosed message areas, wherein each message is associated with a different enclosed message area, and wherein the text and the at least one of the picture, video, map, emoticon, or audio are presented in enclosed message areas in an order that messages are communicated via the communications device.
